(19) United States
(12) Patent Application Publication
(10) Pub. No.: US 2019/0050491 A1
(43) Pub. Date: Feb. 14, 2019

(54) SYSTEMS AND METHODS FOR MANAGING AND DELIVERING REAL PROPERTY DATA

(71) Applicant: Property Records Preservation, LLC, Holdenville, OK (US)

(72) Inventors: Chris Mask, Holdenville, OK (US); Rick Mask, McAlester, OK (US); Kathryn Heath, Holdenville, OK (US); Miranda Freeman, Holdenville, OK (US)

(21) Appl. No.: 15/673,679

(22) Filed: Aug. 10, 2017

(51) Int. Cl. G06F 17/30

(52) U.S. Cl. CPC G06F 17/30896; G06F 17/30873

(57) ABSTRACT

Techniques are disclosed for rendering real property parcel data. A sever component responding to a request for parcel data for a given number of parcels retrieves parcel information and authenticates a user's identification. The server provides parcel data for display on a unique user web page based on preselected parcel endpoints specific to the user. The parcel data includes parcel mapping that combines dynamic and static data to form a parcel map in response to the user's query.

### FIELD

The present invention relates generally to real property records, and particularly to systems and methods for providing aggregated real property parcel data to end-users.

### SUMMARY

The present invention is directed to a computer-implemented method comprising receiving one or more parcel requests for parcel data from a user, determining one or more preselected parcel data endpoints corresponding to the user, retrieving parcel data endpoints corresponding to both the request for parcel data and the preselected parcel data endpoints corresponding to the user. A unique webpage is generated that comprises a display of the retrieved parcel data and at least one active link configured to generate a charge to the user when activated and linked to one parcel data endpoint. The unique webpage is transmitted to the user for display on a user device and the parcel data endpoints returned to the user are processed to determine a charge to the customer based on the type and number of parcel data endpoints returned to the user on the unique webpage for each parcel request.

The invention is further directed to a system comprising a processor and a memory. The memory stores one or more application programs, which when executed on the processor performs an operation for responding to a request for parcel data. The operation comprises determining a current dynamic state for a plurality of parcel data elements tied to a parcel of real property, to be rendered on a webpage and static map image. Parcel data elements corresponding to both the request for parcel data and a plurality of preselected parcel data endpoints corresponding to the user are retrieved. A webpage is generated. The webpage is unique to the user and comprises a display of the dynamic parcel data elements, a portion of which are combined with a static real property map, and at least one active link linked to a parcel data endpoint and configured to generate a charge to the user when activated. The webpage is transmitted to the user for display on a user device.

### BRIEF DESCRIPTION OF THE DRAWINGS

FIG. 1 is a diagrammatic representation of a system for aggregating real property parcel data.

FIG. 2 is a diagrammatic representation of a system for delivering the aggregated real property parcel data of FIG. 1 to end users.

FIG. 3 is an illustration of a server computer system designed and programmed to manage the delivery of real property parcel data to users.

FIG. 4 is a flow chart showing a process for the delivery of real property parcel data to users.

FIG. 5 is a diagrammatic representation of a webpage used to authenticate a user of the system of the present invention.

FIG. 6 is a diagrammatic representation of a unique user webpage permitting the user to search for real property parcel data by county and by physical characteristics of the parcel.

FIG. 7 is a diagrammatic representation of a unique user webpage permitting the user to search for real property parcel data by county and by “Property Use” of the parcel.

FIG. 8 is a diagrammatic representation of a unique user webpage permitting the user to search for real property parcel data by county and by “Owner Information” of the parcel.

FIG. 9 is a diagrammatic representation of a unique user webpage permitting the user to search for real property parcel data by county and by “Sales Record” of the parcel.

FIG. 10 is a diagrammatic representation of a unique user webpage permitting the user to search for real property parcel data by county and using a spatial (Shapefile) file uploaded to the server.

FIG. 11 is a diagrammatic representation of a unique user webpage showing parcel search results sorted by parcel number.

FIG. 12 is a diagrammatic representation of a unique user webpage showing basic information for a parcel search result.

FIG. 13 is a diagrammatic representation of a unique user webpage showing dynamic and static parcel data components combined on an active map.

FIG. 14 is a diagrammatic representation of a unique user webpage showing each charge made to a user for access to parcel data.

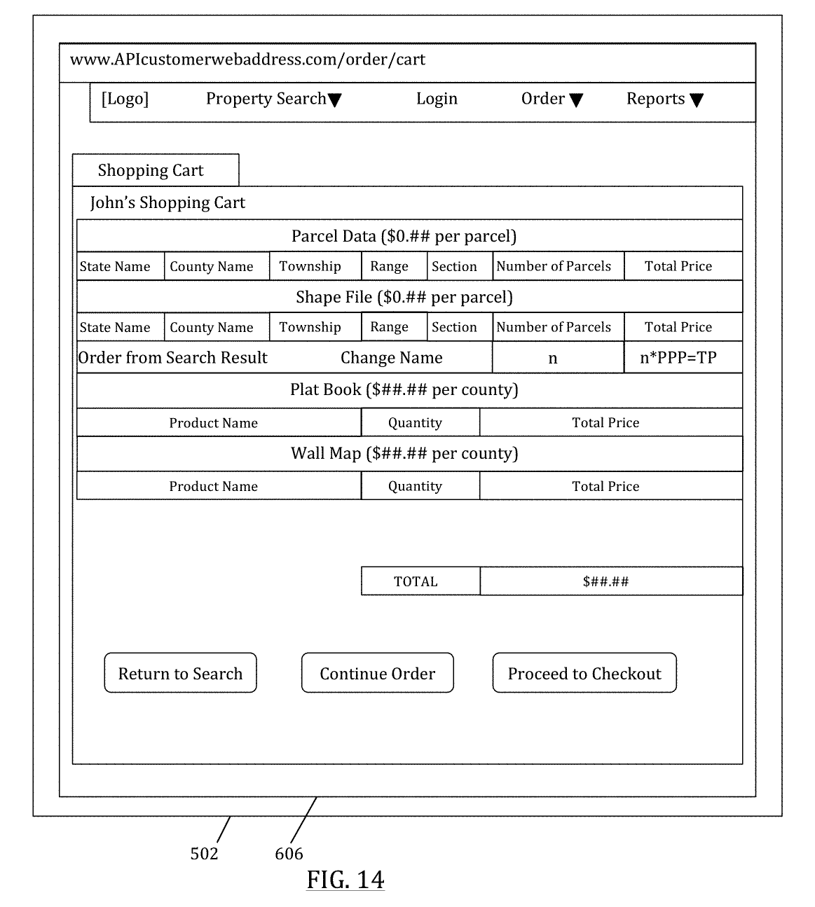

### DESCRIPTION

Industries such as insurance adjusters, real estate sales, and mortgage lenders rely on access to real property records for the collection of data about a single or multiple parcels of land. A local government office such as a county assessor or county clerk typically keeps land records. Unfortunately the land records may not be kept in electronic form, or if they are in electronic form they are not kept in an easily accessible format. Further, there is often a lack of uniformity and consistency of parcel data between government land offices. Therefore, it can be difficult for insurance adjusters to quickly access parcel records across multiple counties in the event of natural disasters like hailstorms, floods, or tornadoes. Thus, there is a need for a robust and well-maintained system to provide real estate parcel data in a clear and concise format that is easily accessible.

The present invention provides an application programming interface (“API”) comprising a set of definitions, protocols, and tools for building application software to deliver property information. The present invention delivers property information to software developers, private industry and governmental entities that have a need for building and land characteristics, situs, historical and current property values, and sales information. The API is organized into a plurality of modules so that developers can select the parcel data needed for their specific application. The API customer is able to build a web interface connected to a parcel information database that will display preselected parcel data endpoints.

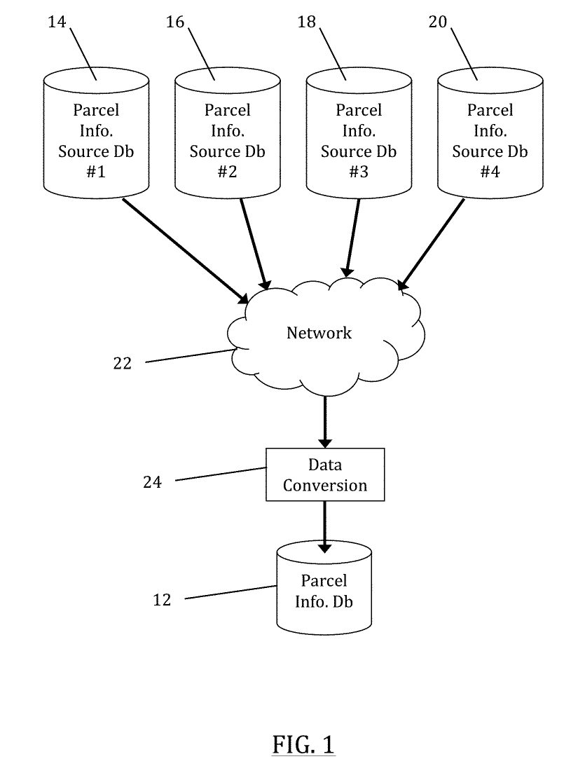

As shown in FIG. 1, the parcel information database 12 is used to aggregate parcel information at a single accessible source. For purposes of illustration, FIG. 1 shows four sources of parcel information. In operation, a processor accesses the parcel information sources databases 14-20 to acquire raw data relating to real property parcels within the source's scope. The processor accesses the sources 14-20 via a network 22, such as the World Wide Web. The source data is aggregated and passed through a data conversion process to conform the data to the API's requirements and standard protocols. The converted data is then stored in the parcel information database 12.

The parcel information aggregated from parcel information sources 14-20 may comprise a plurality of parcel endpoints organized by modules in the API. Parcel endpoints may include parcel information, parcel owners, parcel sales, parcel values, parcel land information, parcel improvements, parcel photos, parcel sketches. The parcel endpoints may be organized into a parcel information module that the API customer may preselect when building out its web end user interface.

A parcel information endpoint may include information such as parcel key, parcel ID, assessment type, deed book, deed page, tax year, inspection date, inspection oper, visual inspection cycle, neighborhood, property use, geographic reference, Cap Code, tax district code, tax district name, school district code, school district name, city, house number, street prefix, street name, street type, street suffix, unit, section, township, range, subdivision code, subdivision name, and legal description.

The parcel owner(s) endpoint may include owner information of a parcel such as owner name, owner addresses, owner city, owner state, and owner zip code.

The parcel sales endpoint will return sales data for the parcel(s) including sale order, sale price, sale date, grantee, grantor, deed book, deed page, revenue stamps, validity code, instrument, and whether the parcel is vacant or improved.

The parcel values endpoint returns values information of the parcel(s) including fair market value, taxable value, assessed value, exemption value, net assessed value, and tax value.

The parcel land information endpoint returns information about the physical characteristics of the parcel including land unit, market area, width, depth, square feet, site, lots, acres, soil type, land use, agricultural acres, and zoning.

The parcel improvements endpoint returns improvements information for a parcel(s) including improvement type, area, story, dimension, design, style, quality, roof materials, roof type, exterior wall characteristics, interior wall type, foundation, flooring materials, number of bedrooms and bathrooms, total rooms, heating type, air conditioning type, year built, functional obsolescence, fireplace type, occupancy, condition, and additions.

The parcel photo(s) and parcel sketch(es) endpoints returns photos and sketches of the parcel including URL's to the photos and sketches.

A parcel spatial information module may comprise two endpoints used to generate maps showing the parcel as requested by the user. The endpoints may return parcel data in Well Known Text markup language to represent the dynamic elements of the parcel on a static map. A second endpoint and can return the parcel ID and a GEOJSON representation of the parcel data on a static GIS map.

A “Search Parcels” module may be used by the API customer to return a list of parcel data keys. In such case there may be eleven (11) endpoints including parcel ID, location, owner, sale, value, land, improvement, residential commercial, manufactured home, and miscellaneous improvement.

The parcel ID endpoint returns a list of parcel keys including country code, state code, county name, and parcel ID. The location endpoint returns a list of parcel keys including country code, state code, county name, section, township, range, subdivision code, subdivision name, block, lot, street number, street name, street type, school district code, tax district code, and legal description. The owner, sale, land, improvements, and value endpoints return the parcel information disclosed hereinabove. Each of the residential, commercial, manufactured home, and miscellaneous endpoints return a list of parcel keys including country code, state code, county name, and parcel keys.

An “option list” module may be built into the customer's API having sixty-two (62) endpoints arranged in seven (7) categories. The option “list district” can return a list of district codes and descriptions for schools, fires, city, and vocational schools. The option “list location” category can return endpoints including tax district, township, range and subdivision. The option “list category” returns the endpoints zoning, soil type, and land use. The option “list category residential” returns seventeen (17) endpoints including design, style, occupancy, quality, condition, roof type, roof material, exterior wall, interior wall, foundation, flooring, air, heating, fireplace type, garage type, porch type, basement. The option list residential and manufactured home categories both include the endpoints design, style, occupancy, quality, condition, roof type roof material, exterior wall, interior wall, foundation, flooring, air, heating, fireplace type, garage type, and porch type. The residential category includes the additional endpoint of basement data. The option “list commercial” category has 14 endpoints including design, occupancy, quality, condition, roof type, roof material, exterior wall, interior wall, foundation flooring, air, heating, perimeter, and frame. The option “list miscellaneous category” has four (4) endpoints including code, design, quality, and condition.

While extensive, the preceding list of categories and parcel data endpoints is not exhaustive of all information a real estate or insurance professional may desire to have access to when assessing the value of or damage to real property. However, such information can be provided in accordance with the present invention in a easily accessible format from a single source as viewed by the end user and include numerous data points from a plurality of real property record sources.

In addition to the modules discussed above, the API customer may include a “User Usage” module. This module may comprise one endpoint and return usage information including year, month, endpoint, and usage data. The user usage module permits the API customer to track charges against the customer's account based on the usage of the customer.

When the end user submits a request for parcel(s) information through the customer's API application configured to access the parcel information database 12 (FIG. 1), an accounting record is generated to indicate which information elements returned are provided free of charge and which are paid results. For example, the API may be configured to charge the customer a flat rate per parcel request. An example rate range may be from $0.00 per parcel request to $0.20 per request. Alternatively, if more than one parcel is searched a bulk rate may be applied and graduated based on the number of parcel requests. The charges to the customer are shown through the user's webpage and charged through a prearranged transaction protocol.

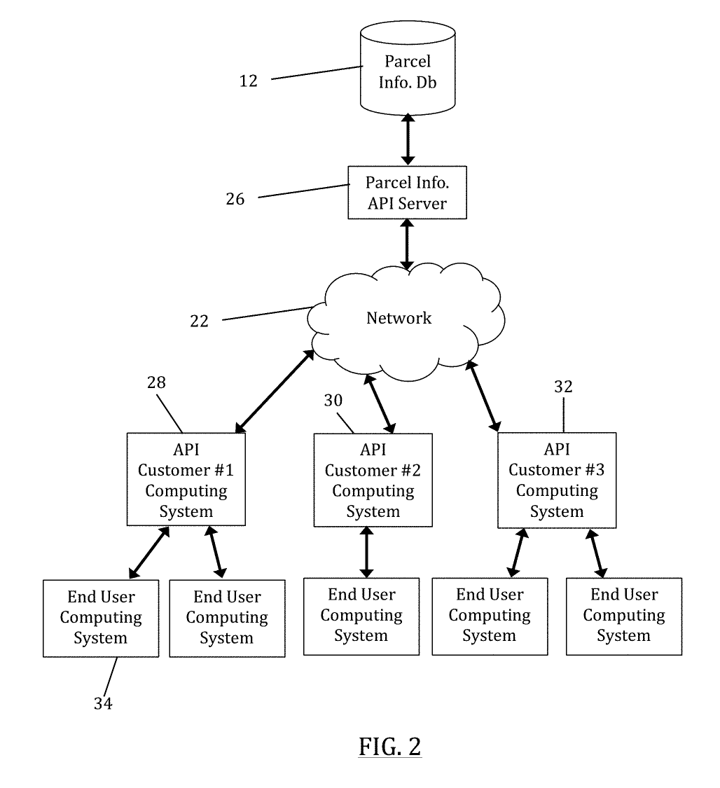

As shown in FIG. 2, the parcel information database 12 is accessible by a Parcel information API server 26. The API server 26 sends and receives data to and from the API customer servers 28-32 via the network 22. The customer servers 28-32 are configured to run the API to receive parcel requests from end user computing systems 34 and to transmit data received from the parcel information server 26 in response to a parcel data request. The customers' servers 28-32 pass along parcel search requests to the parcel information API server 26. The server 26 processes the request and accesses the database 12 to retrieve parcel information corresponding to the request. The user can search using many different input criteria. For example, the user can search by physical information, owner information, property use information or sales information. Once the API Server 26 locates the property, the API server generates a unique user webpage to display all of the data available for the parcel(s) including a map having static and dynamic features. In accordance with the present invention the user can save their searches, print them, or create comparison models.

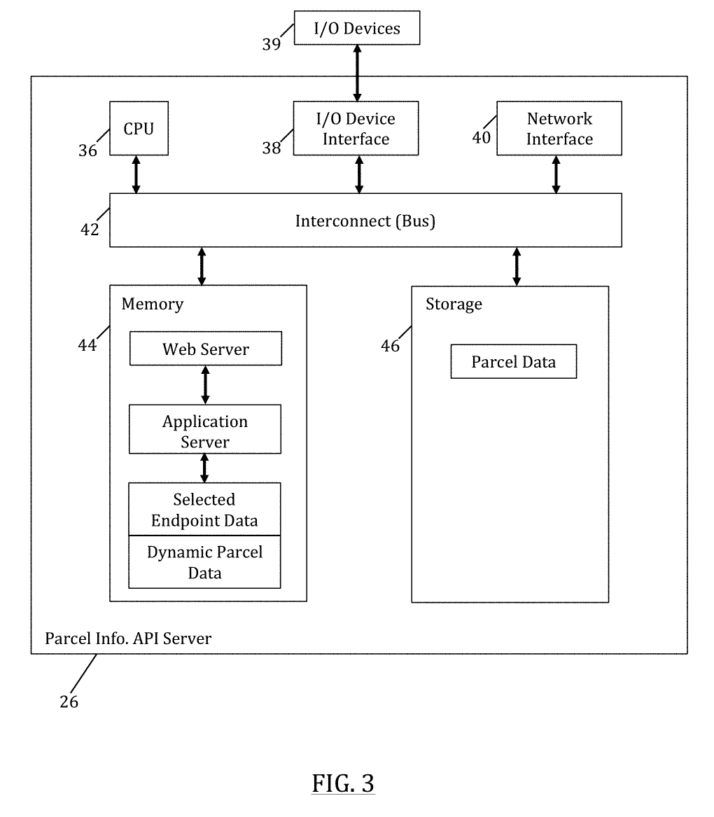

Turning now to FIG. 3, a diagrammatic representation of the Parcel information API server 26 to send parcel data to requesting users, according to an embodiment of the invention is shown. As shown, the server includes, without limitation, a processor/CPU 36, an I/O device interface 38 connected to I/O devices 39 (e.g., keyboard, display and pointing devices), and a network interface 40, all interconnected through an interconnect (bus) 42.

The CPU 36 retrieves and executes programming instructions stored in memory 44. Similarly, the CPU 36 stores and retrieves application data residing in the memory 44. Interconnect 42 facilitates transmission, such as of programming instructions and application data, between the CPU 36, I/O devices interface 38, storage 46, network interface 40, and memory 44. CPU 36 is included to be representative of a single CPU, multiple CPUs, a single CPU having multiple processing cores, and the like. And the memory 44 is generally included to be representative of a random access memory. The storage 46 may be a disk drive storage device. Although shown as a single unit, the storage 46 may be a combination of fixed and/or removable storage devices, such as fixed disc drives, floppy disc drives, tape drives, removable memory cards or optical storage, network attached storage, or a storage area-network. The memory may comprise a hosted scalable cloud-based parcel data element storage queue. Likewise, the memory may comprise a retrieved parcel data element storage medium to store parcel data in a database for later and frequent access as a user's “favorites.”

As shown, the memory 44 includes a web server, an application server, dynamic parcel data and selected endpoint data. The web server provides a software application configured to respond to webpage requests received from an end user computer. The web server may pass such a request to the application server, which generates content for the web server to return to the end user device. For example, in the present invention, a user may access a webpage that allows the user to compose a parcel search query. In response, the application server generates elements of static map and webpage elements and dynamic webpage and map elements to return in response to the request.

The Parcel Information API Server may comprise a third-party hosting solution configured to store the parcel information, receive and respond to parcel queries, and authenticate the credentials of users. One such solution is Amazon's Simple Storage Service application programming interface utilizing Amazon's Signature 4 Authorization Method.

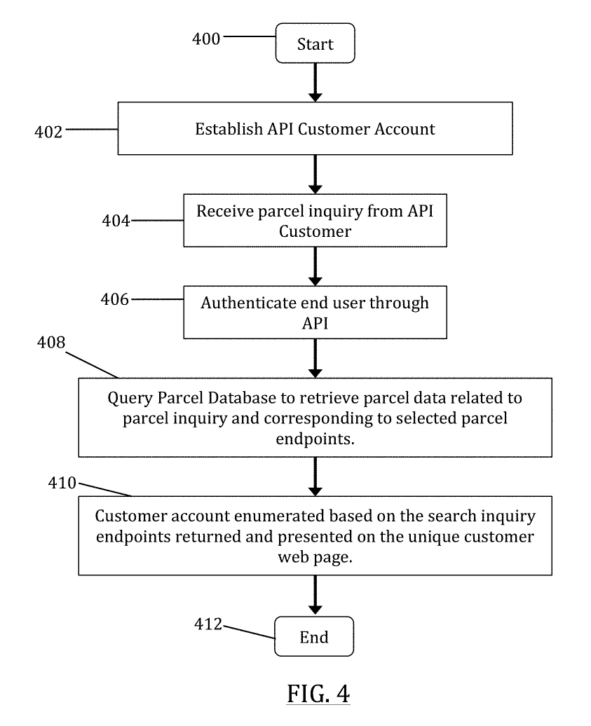

FIG. 4 illustrates a method for providing parcel data to a requesting user, according to one embodiment of the inventions. As shown, the method begins a step 400. At step 402 an API customer account is established. During this step the API customer develops a custom web interface for its end users and preselects the parcel endpoints it wishes to have returned in response to a parcel inquiry. At step 404 the parcel information API Server 26 (FIG. 1) receives a parcel inquiry from the API customer. Next, the end user is authenticated through the customer API at step 406.

During step 408 the Parcel database is queried to retrieve parcel data related to the parcel inquiry search parameters and corresponding to selected parcel endpoints. The parcel may be located using physical characteristics of the property, ownership information, property use characteristics, sales records, or using a shapefile generated by the user. At step 410 the customer account is charged based on the search inquiry endpoints returned and presented on the unique customer webpage. The process ends at step 412.

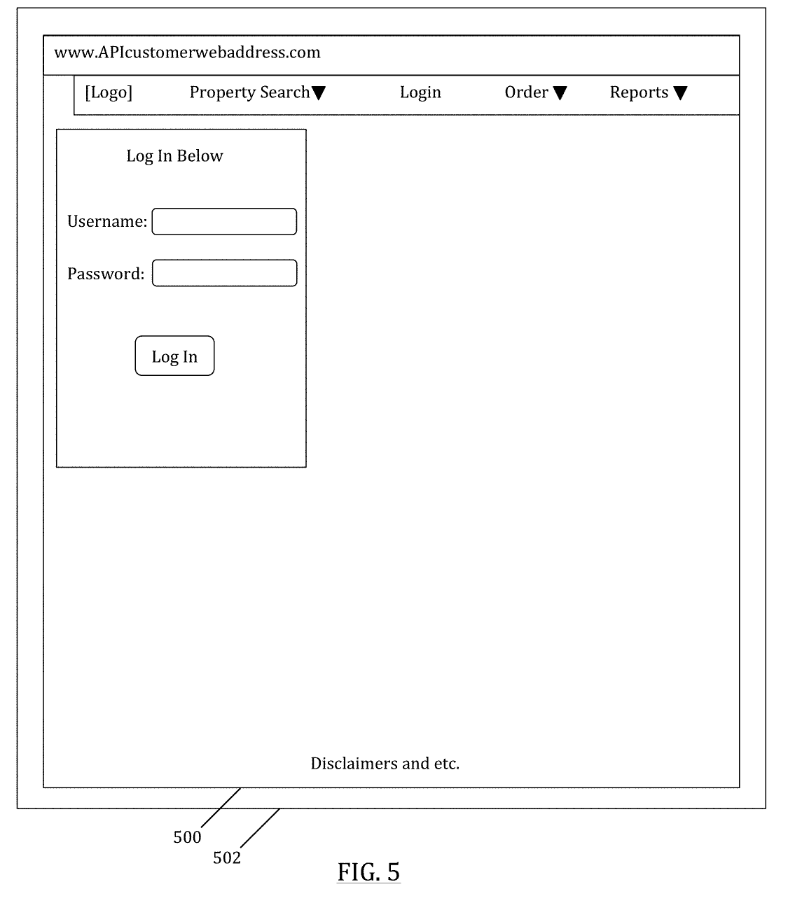

FIG. 5 provides an example of a user authentication page 500 displayed on a user device 502. The authentication page may be located at a URL selected by the API customer. The page will generally have a clickable tool bar at the top of the page that includes the API customer's logo, a property search drop-down link, a login link, an order link, and a reports link. The page will have a section configured to receive the end users authentication information. In the example shown in FIG. 5, the user provides a username and password.

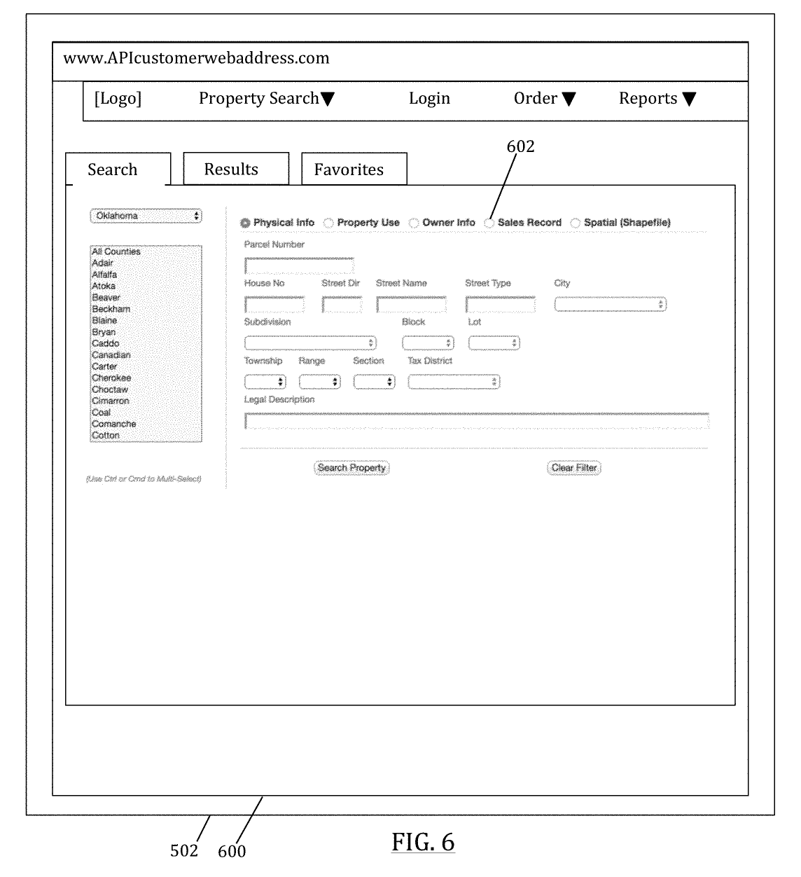

In FIG. 6 an embodiment of the “Search” page 600 is shown on user device 502. The search page 600 has a plurality of radio buttons 602 across the top of the page that permit the user to select different search criteria. The example page 600 has radio buttons for user to input physical information, property use, owner information, sales records, and spatial data.

The search page of FIG. 6 has a plurality of fields configured to receive input form the user related to the parcel(s) physical information. The page 600 also has a drop down menu and list of counties that user may select to search. The physical information search fields may include parcel number, address, subdivision, block, lot, township, range, section, tax district and legal description.

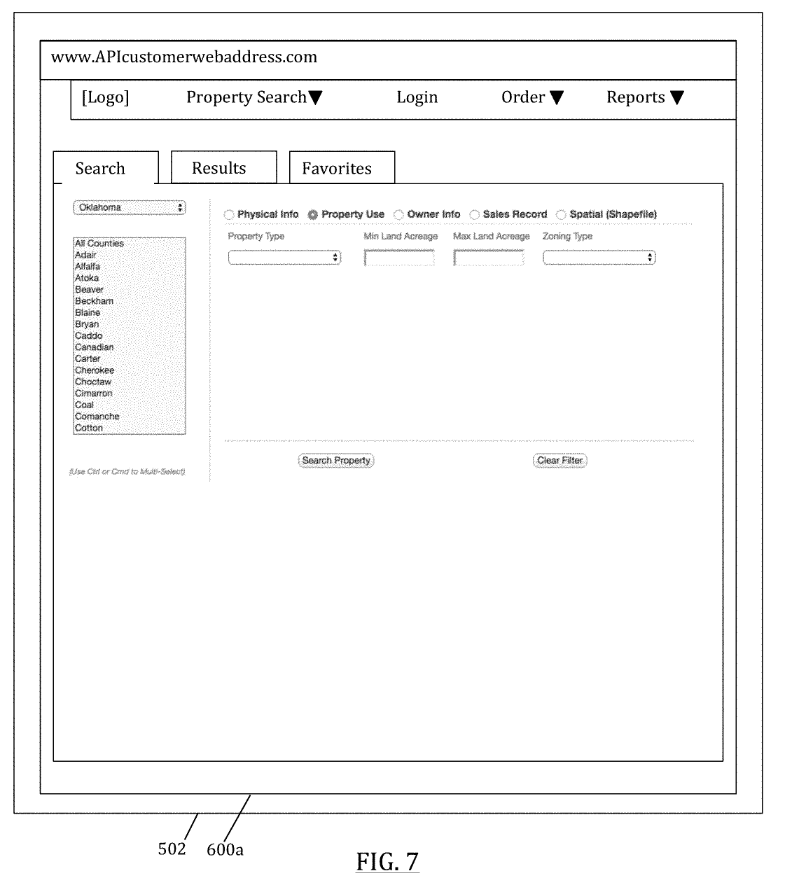

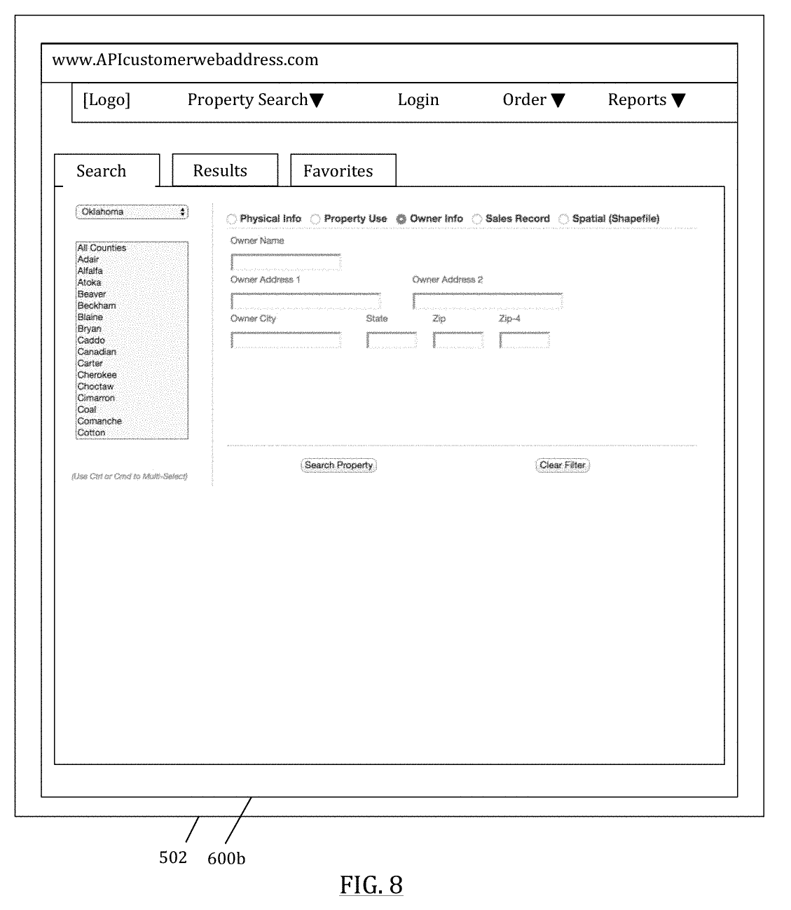

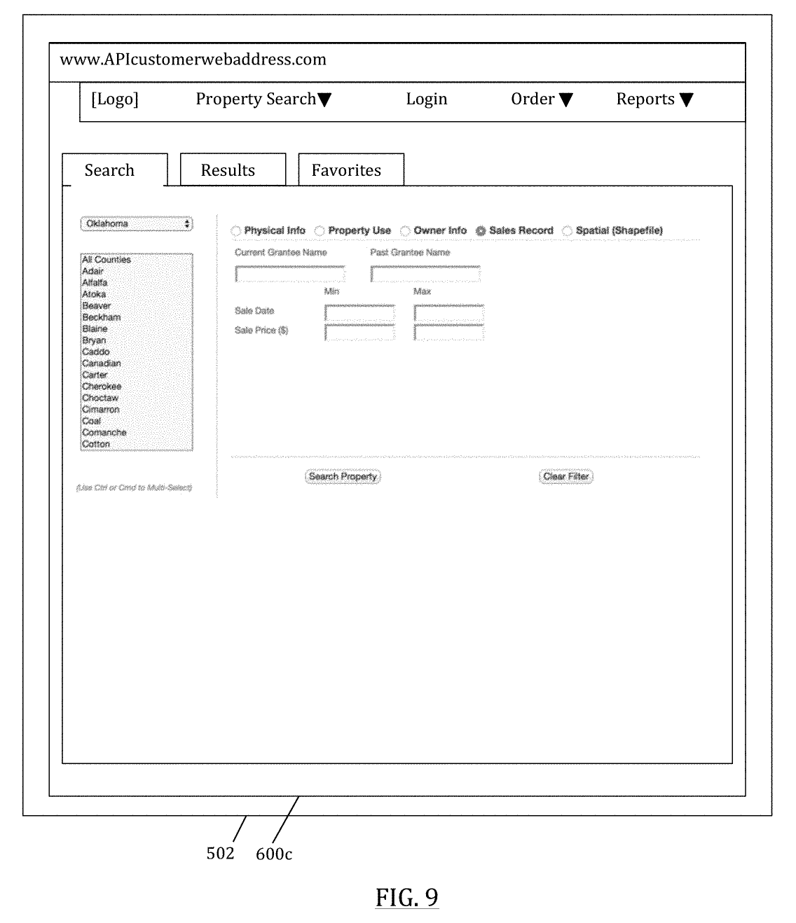

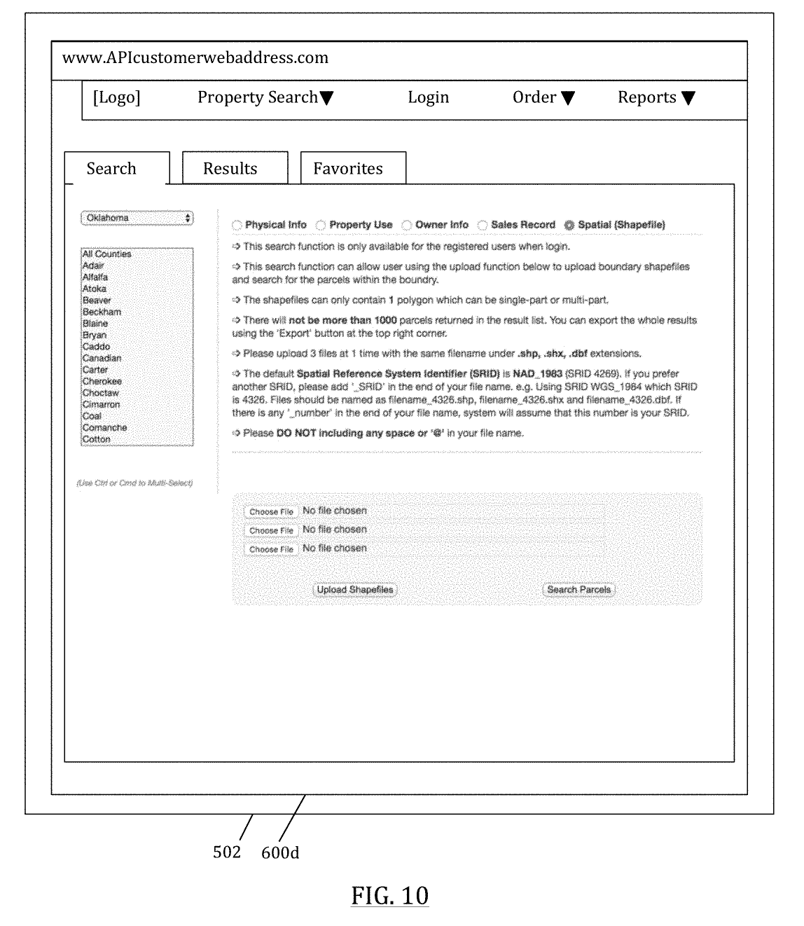

FIG. 7 provides an example of the search page 600a wherein the user has selected to use “Property Use” information to retrieve parcel data. In FIG. 8, page 600b is a search page configured to receive owner information such as the owner name, owner address, city, state, and zip code. FIG. 9 shows a search page 600c displayed on a user device 502. The search page of FIG. 9 permits the user to search for parcel information by sales records such a grantee name, grantor name, sale date, or sale price. While in search page 600d FIG. 10 the user may upload a shape file to search for parcels within a boundary. This function is particularly useful in the even of a natural disaster. The user can create a shape file that has an overlay of the damage area on a GIS map and then upload the map to the system and search for parcel data.

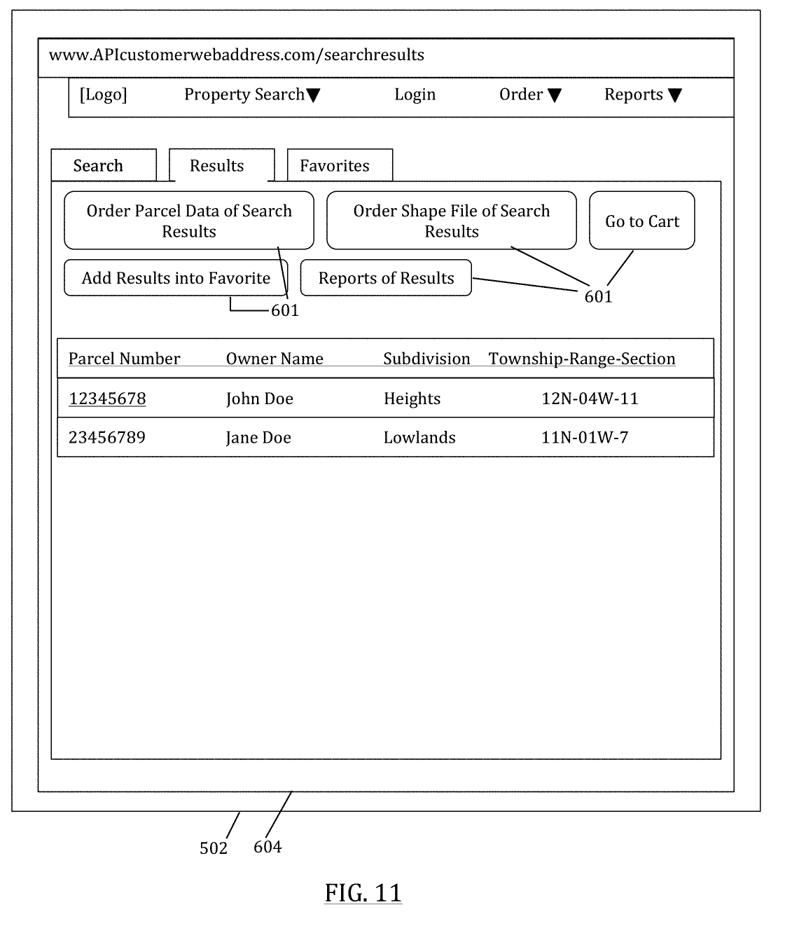

Turning to FIG. 11, an exemplary result page 604 is shown displayed on the user's display device 502. The result page provides a list of the parcels that match the search parameters provided by the user. In this case the parcels are sorted by Parcel Number and show the Owner's Name, Sub-division, and Location by township, range, and section. The Parcel Number may comprise an active link. When the user clicks the active link a bottom portion of the page may be populated with the preselected parcel endpoints for the user. In this case, the user is shown basic information for the parcel including parcel ID, addition, township-range-section, deed book number, deed page number, land unit, owner information, parcel location, sales information, parcel values, building information a building photo and a perimeter sketch of the building.

The result page 604 also comprises a plurality of active buttons 601. One of the plurality of active buttons 601 may be activated by the user to order parcel data of search results (“Order Parcel Data of Search Results”), order a shape file of the search results (“Order Shape File of Search Results”), add results into a favorite file stored in the users profile on the API server user database (“Add Results into Favorite”), receive reports of the results (“Reports of Results”), or go to the user's virtual shopping cart (“Go to Cart”).

The displayed information is dynamic and is regularly updated or changed when the ownership of the property changes, a photo or sketch is added or there is any other relevant change in the property data. The template on which the information is displayed may be static and configured in response to the user's preselected parcel endpoints. If the user clicks a different parcel ID active link the page will refresh and the template will repopulate with parcel information corresponding to the selected parcel.

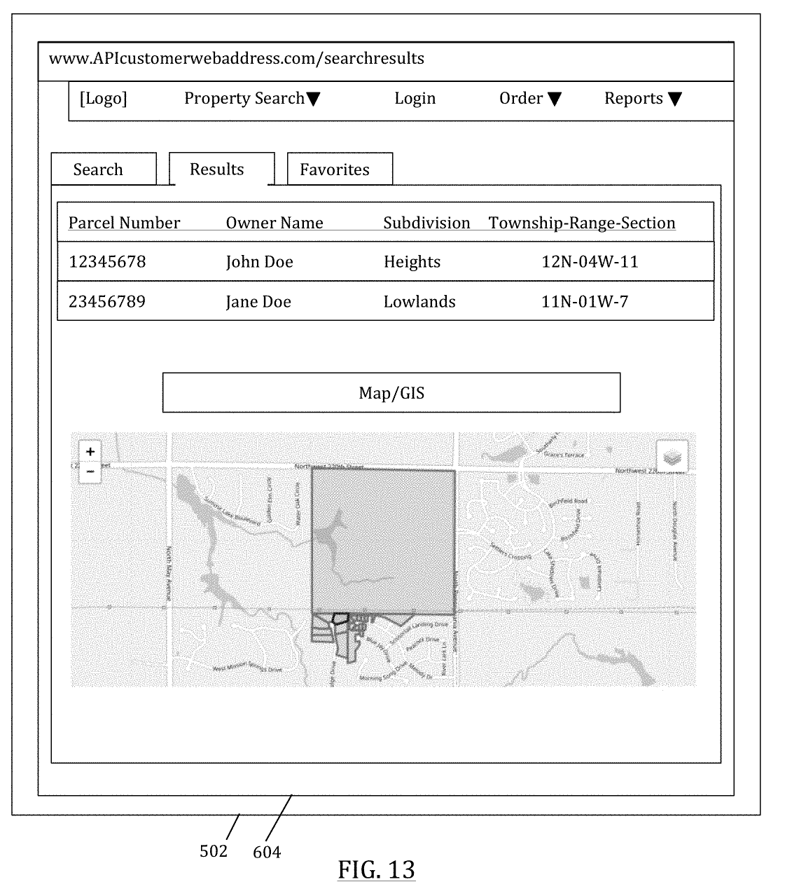

As shown in FIG. 13, the user may also be presented with a map page 604 that includes the parcel of interest with a boundary and shading of a first color and adjacent properties in a second color. Alternatively, the map may show a plurality of parcels of interest in a first color and adjacent or secondary parcels in a second color. The map may be configured so that clicking on a parcel bearing the second color reveals the parcel ID, or other information, to the user.

After concluding their search(es) and saving or printing the relevant parcel data, the user may proceed to a shopping cart page 606 that is unique to the user. The processor populates the shopping cart page 606 with data related to the number of parcel, shape file, or plat book results returned and calculates a charge to the user's based on the user's preselected parcel endpoints and predetermined rates for parcel endpoint access.

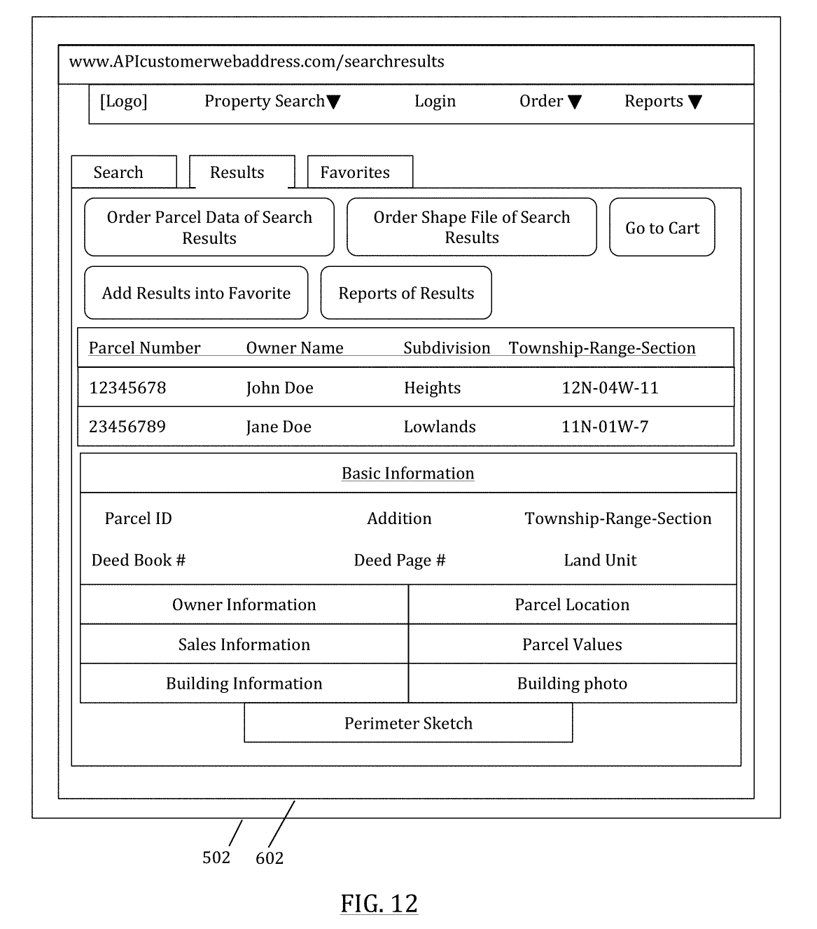

In operation, one or more parcel requests for parcel data are received at the parcel information server from a user. The processor determines one or more preselected parcel endpoints corresponding to the user and retrieves parcel data endpoints corresponding to both the request for parcel data and the preselected parcel data endpoints corresponding to the user. The processor generates a unique webpage comprising a display of the retrieved parcel data and at least one active link configured to generate a charge to the user when activated and linked to one parcel data endpoint. In the discussion above, this charge may occur when the user accesses the GIS map or when the user accesses the basic parcel information page (FIG. 12). The unique webpage is transmitted to the user for display on the user device. The parcel endpoints returned to the user are processed to determine a charge to the customer based on the type and number of parcel data endpoints returned to the user on the unique webpage for each parcel request.

As discussed above, each of the parcel data endpoints may comprise dynamic data about a real property parcel. In this way, the unique webpage may comprise a static map combined with dynamic map elements to highlight boundaries of one or more parcels of the parcel requests in a first color and one or more parcels adjacent the requested parcels in a second color.

Although the present invention has been described with respect to preferred embodiment, various changes and modifications may be suggested to one skilled in the art, and it is intended that the present invention encompass such changes and modifications as fall within the scope of this disclosure.

What is claimed is:

1. A computer-implemented method comprising:
receiving one or more parcel requests for parcel data from a user;
determining one or more preselected parcel data endpoints corresponding to the user;
retrieving parcel data endpoints corresponding to both the request for parcel data and the preselected parcel data endpoints corresponding to the user;
generating a unique webpage comprising a display of the retrieved parcel data and at least one active link configured to generate a charge to the user when activated and linked to one parcel data endpoint;
transmitting the unique webpage to the user for display on a user device; and
processing the parcel data endpoints returned to the user to determine a charge to the customer based on the type and number of parcel data endpoints returned to the user on the unique webpage for each parcel request.

2. The method of claim 1 wherein each of the parcel data endpoints comprises dynamic data about a real property parcel.

3. The method of claim 1 wherein the unique webpage comprises a static map combined with dynamic map elements to highlight boundaries of one or more parcels of the parcel requests in a first color.

4. The method of claim 3 wherein a boundary and a space within the boundary of each parcel adjacent the one or more parcels of the parcel request is shaded a second color.

5. The method of claim 1 in which parcel data comprises owner, location, sales, value, improvements, photos, sketches, and land information.

6. The method of claim 3 wherein the dynamic map elements are formatted as GeoJSON objects.

7. The method of claim 1 wherein the parcel request comprises a parcel owner name.

8. The method of claim 1 wherein the parcel request comprises section, township and range values.

9. The method of claim 1 in which a parcel module is assigned to the user, the parcel data module comprising a parcel information endpoints, parcel owner endpoints, parcel sales endpoints, parcel value endpoints, parcel land endpoints, parcel improvement endpoints, parcel photo endpoints, and parcel sketch endpoints.

10. The method of claim 1 in which a parcel spatial module is assigned to the user, the parcel spatial module comprising GeoJSON static and dynamic map data for the parcel.

11. The method of claim 1 further comprising an endpoint module comprising usage and charge data.

12. A system, comprising:
a processor; and
a memory storing one or more application programs, which when executed on the processor, performs an operation for responding to a request for parcel data, the operation comprising:
determining a current dynamic state for a plurality of parcel data elements, for a parcel of real property, to be rendered on a webpage and static map image;
retrieving parcel data elements corresponding to both the request for parcel data and a plurality of preselected parcel data endpoints corresponding to the user;
generating a webpage unique to the user that comprises a display of the dynamic parcel data elements, a portion of which are combined with a static real property map, and at least one active link configured to generate a charge to the user when activated and linked to one parcel data endpoint; and
transmitting the unique webpage to the user for display on a user device.

13. The system of claim 12 further comprising a digital medium to aggregate parcel data elements from the plurality data sources and to transmit the parcel data elements to the memory.

14. The system of claim 12 wherein the memory comprises a scalable cloud-based parcel data element storage queue.

15. The system of claim 12 further comprising a retrieved parcel data element storage medium to store the parcel data in a database for later access.

16. The system of claim 12 wherein the webpage comprises dynamic map elements based combined with the static map to highlight boundaries of one or more parcels of the parcel request in a first color.

17. The system of claim 12 in which the plurality of parcel data elements comprise owner, location, sales, value, improvements, photos, sketches, and land information.

18. The system of claim 12 in which the preselected parcel data endpoints comprise one or more of parcel information, parcel owner, parcel sales, parcel value, parcel land, parcel improvements, parcel photos, and parcel sketches.

19. The system of claim 12 further comprising a plurality of connections between the processor and a plurality of end users.

20. The system of claim 12 wherein each end user has preselected a module comprising a set of parcel data endpoints and wherein each user receives parcel data elements on a webpage corresponding to the preselected parcel data endpoints in response to a request for parcel data and wherein the request for parcel data is specific to one or more real property parcels within a region.
